(19) United States
(12) Patent Application Publication
(10) Pub. No.: US 2008/0193901 A1
(43) Pub. Date: Aug. 14, 2008

(54) Dental Prosthesis and Its Manufacturing Method

(76) Inventor: Oh-dal Kwon, Daegu (KR)

Correspondence Address: SEYFARTH SHAW LLP, 131 S. DEARBORN ST., SUITE 2400, CHICAGO, IL, 60603-5803, US

(21) Appl. No.: 11/996,667

(22) PCT Filed: Feb. 17, 2006
(86) PCT No.: PCT/KR06/00543

§ 371 Date: Jan. 24, 2008

(30) Foreign Application Priority Data
Jul. 26, 2005 (KR) 10-2005-0067676
Jan. 6, 2006 (KR) 10-2006-0001545
Jan. 9, 2006 (KR) 10-2006-0002082

(51) Int. Cl. A61C 5/10

(52) U.S. Cl. 433/223

(57) ABSTRACT

Disclosed herein are a dental prosthesis and its manufacturing method, which can recover a damaged tooth without grinding of the buccal and lingual sides, and cover the buccal and lingual sides of a moving tooth and adjacent teeth, the nonfunctional cusp, and the occlusal surface of the tooth which is not in contact with the opposite tooth, thereby reducing a moving level of the tooth, recovering functions of the tooth and extending lifetime of the tooth by bonding the dental prosthesis onto the moving tooth and the adjacent teeth. The dental prosthesis is divided into an integrated type having only a buccal coverage part or a lingual coverage part, and a separated type having a buccal coverage part and a lingual coverage part, which are coupled with each other in an engagement form or a contact form. The manufacturing method of the dental prosthesis includes the steps of duplicating a work pattern, waxing up the duplicated pattern, holding a sprue on the duplicated pattern in a state where the duplicated pattern is waxed up, investing, burning out, and casting the wax pattern in order to obtain a precise dental prosthesis.

### TECHNICAL FIELD

The present invention relates to a dental prosthesis and its manufacturing method for recovering functions of a damaged tooth. More particularly, the present invention relates to a dental prosthesis, which can recover the damaged tooth by grinding only to a contact area between the damaged tooth and an adjacent tooth without grinding of the buccal side and the lingual side when the occlusal surface is ground during endodontic treatment, and can recover the damaged tooth with no grinding when the occlusal surface which is not in contact with the opposite tooth is recovered or a broken tooth is recovered, and a method for manufacturing the dental prosthesis which includes the steps of duplicating a work pattern, waxing up the duplicated pattern, holding a sprue on the wax pattern, investing, burning out and casting the wax pattern.

### BACKGROUND ART

In general, till now, during endodontic treatment, when the occlusal surface is ground or a tooth is broken, the tooth is ground in such a way that there is no undercut from a contact surface of the tooth to the buccal side and the lingual side, and a prosthesis is put on a work pattern without a duplicated pattern to recover functions of the tooth. Particularly, in case of a moving tooth, the tooth is generally recovered by a process of forming an indented portion on the occlusal surface of the tooth, putting a wire in the indented portion, and filling the indented portion with resin, amalgam or other filler. However, in the above case, the conventional prosthesis has a disadvantage in that there is a difficulty to masticate foods since the occlusal surface is ground much, and the filler is easily removed when the tooth is severely moved, and a sensitive reaction is shown after the endodontic treatment. Moreover, the conventional prosthesis has another disadvantage in that a loss of tooth substances is large in quantity, and tooth decay is sometimes caused since cement is melted after the prosthetic restitution due to improper grinding. However, the present invention remarkably reduces grinding of tooth substance since it can be mounted on the tooth using elasticity of metal and projections without grinding of tooth substance at the buccal side and the lingual even though there is an undercut.

### DISCLOSURE OF INVENTION

### Technical Problem

Accordingly, it is an object of the present invention to provide a dental prosthesis and its manufacturing method, which can extend lifetime and recover functions of teeth by reducing movement of the teeth through attachment between adjacent moving teeth or attachment between a moving tooth and an adjacent sound teeth, and which can recover a damaged tooth without damage of tooth substance. To achieve the above object, the prosthesis must be fixed and keep its holding force with no or little grinding of the buccal side while protecting the tooth substance which becomes weak.

### Advantageous Effects

The dental prosthesis according to the present invention can recover a damaged tooth by grinding only a portion of the tooth of which enamel is damaged, extend lifetime of a severely moving tooth and recover functions of the moving tooth, prevent damage of soft tissue which may be caused during grinding of the tooth, remarkably reduce a dental treatment time period since it does not need anesthesia, and minimize a loss of adjacent teeth since it can prevent melting of cement due to grinding of an improper tooth.

### BRIEF DESCRIPTION OF THE DRAWINGS

FIG. 1 is an exploded perspective view showing a mounted state of a dental prosthesis according to the present invention;

FIG. 2 is a perspective view of a separated type coverage part according to the present invention;

FIG. 3 is a view showing an engagement form of the separated type coverage part according to the present invention;

FIG. 4 is a side view showing a ground portion of a tooth in a state where a conventional dental prosthesis is applied;

FIG. 5 is a side view showing a ground portion of a tooth for mounting a dental prosthesis according to the present invention;

FIG. 6 is a side view for comparing the ground portion for mounting the conventional dental prosthesis with the ground portion for mounting the dental prosthesis according to the present invention;

FIG. 7 is a perspective view showing a state where the lingual coverage part covers to the greatest bulge part of the buccal side;

FIG. 8 is a perspective view showing a state where the lingual coverage part covers to the infrabulge portion of the buccal side;

FIG. 10 is a perspective view showing a state where the buccal and lingual coverage part covers to the margin of the buccal and lingual sides;

FIG. 11 is a perspective view showing forms of a groove of the buccal and lingual coverage part;

FIG. 12 is a side view showing a mounted state of a fixed dental prosthesis according to the present invention;

FIG. 13 is a side view and a plan view showing a form of a projection formed on the fixed dental prosthesis and a form of an indented portion formed on a tooth;

FIG. 14 is a side view and a plan view showing another form of the projection formed on the fixed dental prosthesis and another form of the indented portion formed on the tooth;

FIG. 15 is a side view and a plan view showing another form of the projection formed on the fixed dental prosthesis and another form of the indented portion formed on the tooth; and

FIG. 16 is a side view and a plan view showing another form of the projection formed on the fixed dental prosthesis and another form of the indented portion formed on the tooth.

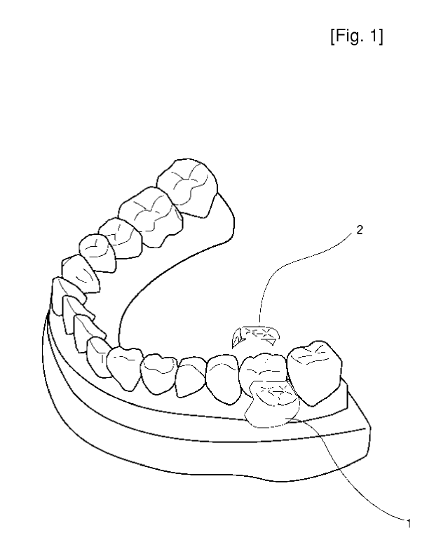

### BEST MODE FOR CARRYING OUT THE INVENTION

Reference will now be made in detail to the preferred embodiments of the present invention, examples of which are illustrated in the accompanying drawings.

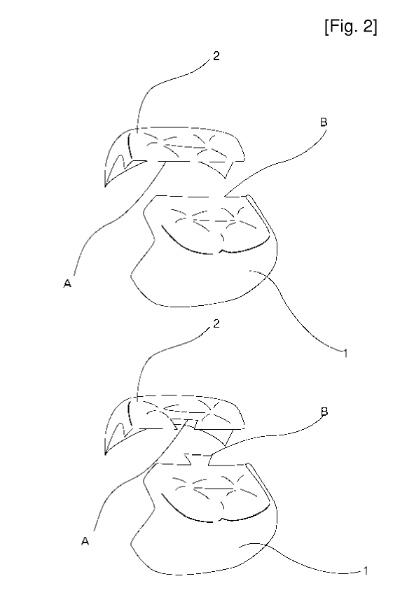

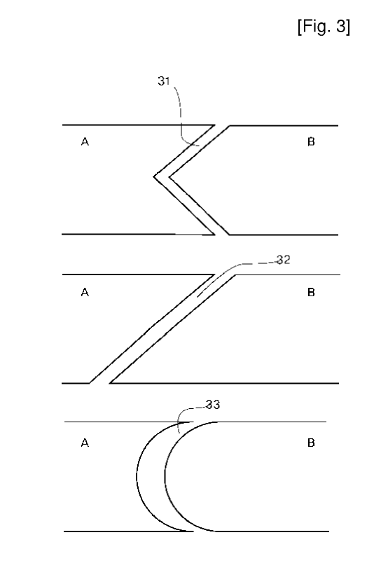

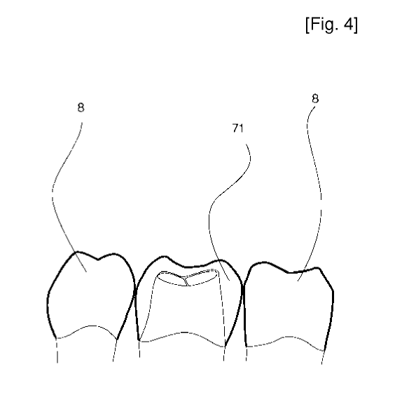

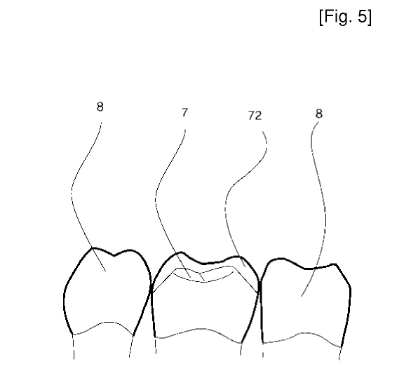

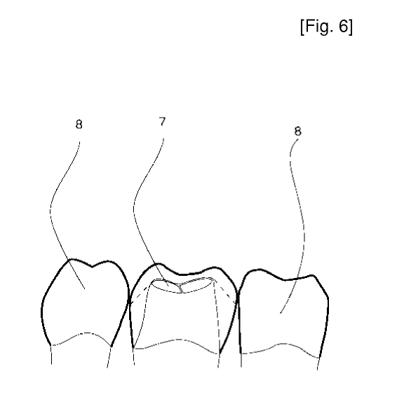

First, a piece crown which is a dental prosthesis according to the present invention can recover a damaged tooth by grinding only a contact surface between the damage tooth and an adjacent tooth 8 without grinding of the buccal side and the lingual side when the occlusal surface is ground during endodontic treatment (FIG. 5), and also recover the occlusal surface, which is not in contact with the opposite tooth, and a broken tooth with no grinding of teeth. A separated type piece crown (FIG. 2) according to the present invention includes a buccal coverage part 1 and a lingual coverage part 2. The buccal coverage part 1 and the lingual coverage part 2 are coupled with each other in an engagement type or a contact type. At this time, the engaged portion or the contact portion between the buccal coverage part 1 and the lingual coverage part 2 has a predetermined angle (FIG. 3) so as to prevent melting of cement by obtaining a close contact level using ductility of metal during mastication. At this time, the engaged portion or the contact portion may have a bevel-faced form or a V-shaped or U-shaped form.

As described later, the buccal and lingual coverage parts 1 and 2 are produced to conform to the original form of the buccal and lingual sides of the tooth, thereby providing reinforced holding force due to undercut of the lingual side ad the buccal side.

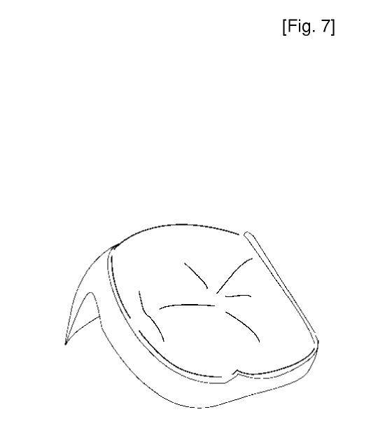

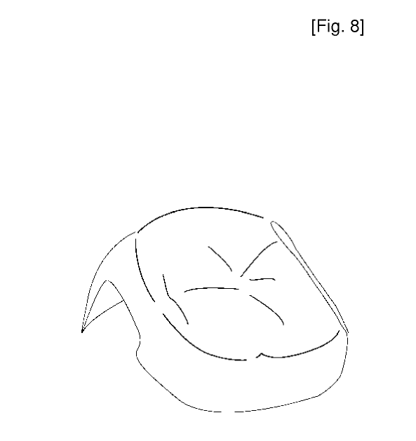

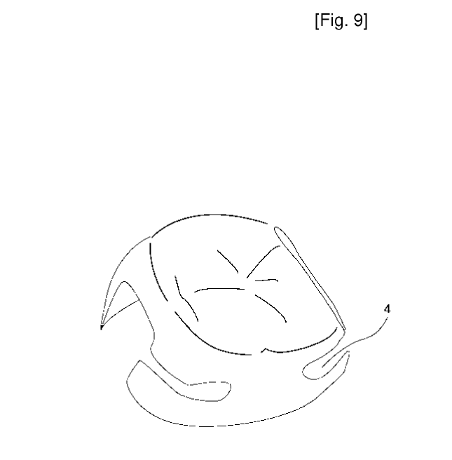

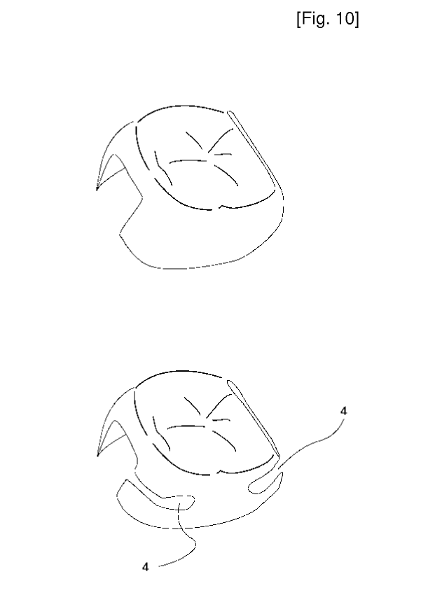

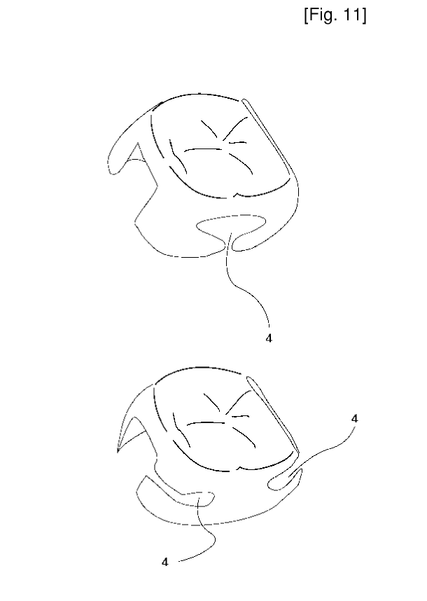

An integrated type piece crown according to the present invention includes only a lingual coverage part (FIGS. 7, 8, 9, 10 and 11). In the integrated type piece crown, the lingual coverage part covers to the lingual side, the occlusal surface and the greatest bulge portion of the buccal side (FIG. 7), or covers to the infrabulge (FIG. 8) or the margin by forming a groove 4 in the greatest bulge portion and increasing elasticity of metal (FIG. 9).

Alternatively, the integrated type piece crown may include only a buccal coverage part (FIGS. 7, 8, 9, 10 and 11). In the integrated type piece crown, the buccal coverage part covers to the lingual side, the occlusal surface and the greatest bulge portion of the buccal side (FIG. 7), or covers to the infrabulge (FIG. 8) or the margin by forming a groove 4 in the greatest bulge portion and increasing elasticity of metal (FIG. 9).

The buccal or lingual coverage part is produced by the steps of duplicating a work pattern, waxing up the duplicated pattern, holding a sprue on the duplicated pattern in a state where the duplicated model is waxed up, investing, burning out, casting and polishing the wax pattern, and mounting it to the work pattern using elasticity of metal. The crown bridge manufactured by the above process can cover the damaged portion of the tooth without grinding of the buccal and lingual sides.

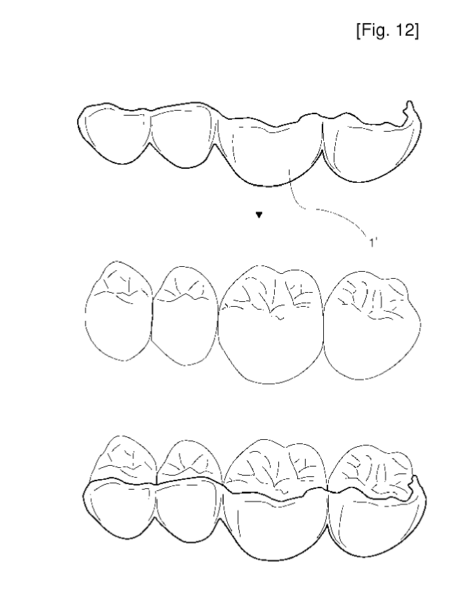

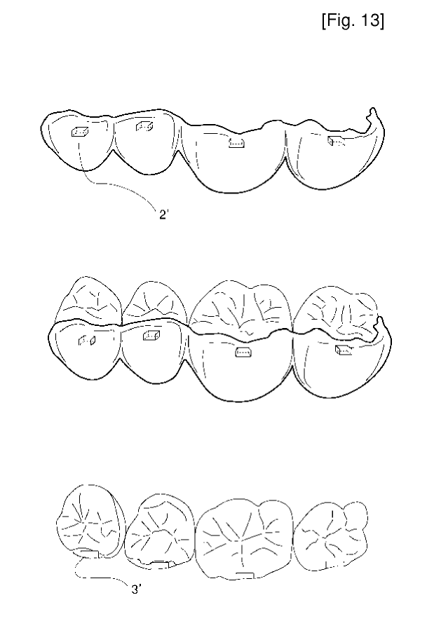

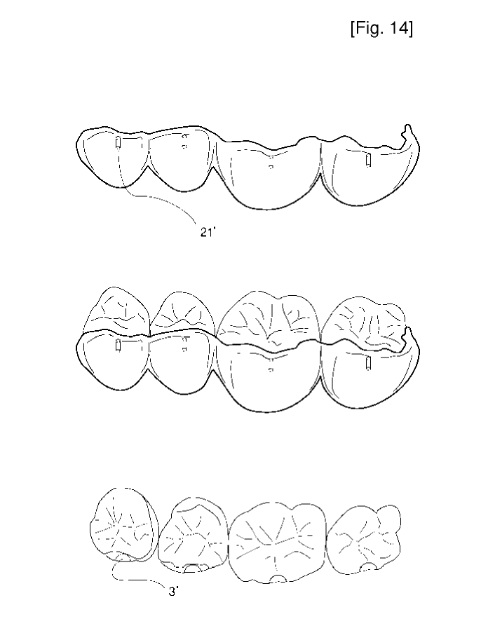

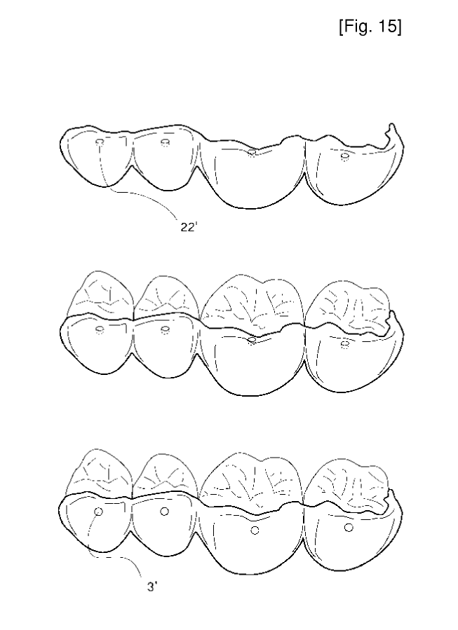

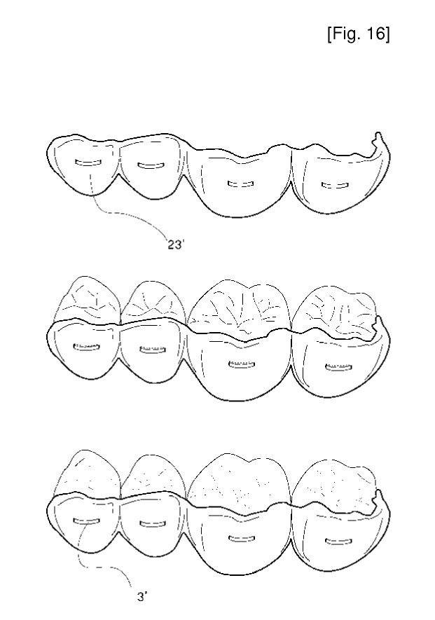

Hereinafter, referring to FIGS. 12 to 16, a process for an effectively dental prosthesis of a moving tooth will be described. The crown bridge according to the present invention can effectively recover the moving tooth using the adjacent teeth of the moving tooth. A fixed dental prosthesis 1 is integrally attached on the buccal side or the lingual side of a number of teeth in series in order to fix the teeth using rigidity of metal. To fix the teeth using the buccal and lingual sides, the nonfunctional cusp, and the occlusal surface of the moving tooth, which is not in contact with the opposite tooth, the fixed dental prosthesis 1 is generally fixed on the buccal side in the upper jaw-bone and on the lingual side in the lower jaw-bone (FIG. 12). At this time, if there is an undercut, the dental prosthesis is produced by the steps of duplicating a work pattern, waxing up the duplicated pattern, holding a sprue on the duplicated pattern in a state where the pattern is waxed up, investing, burning out and casting the wax pattern, and bonding it to the work pattern using elasticity of metal. However, if there is no undercut, the dental prosthesis is produced by the steps of waxing up a work pattern, holding a sprue on the wax pattern, investing, burning out, and casting the wax pattern. In order to reduce movement of the tooth and firmly fix the tooth, in the case of the upper jaw-bone, an indented portion 3 is formed on the buccal side (including or not including the occlusal surface), and in the case of the lower jaw-bone, an indented portion 3 is formed on the lingual side (including or not including the occlusal surface). At this time, the indented portion 3 is formed within a range that a patient does not feel any rejection. As shown in FIGS. 13 to 16, the dental prosthesis according to the present invention includes the fixed dental prosthesis 1, a projection 2 formed on the fixed dental prosthesis 1, and the indented portion 3 formed on the tooth. At this time, the indented portion 3 may adopt one of a rectangle form, a U-shaped form, a V-shaped form, a dot form, a hole form, a scratch form, and so on (21 in FIG. 14, 22 in FIG. 15, 23 in FIG. 16).

1. A dental prosthesis comprising: a buccal coverage part produced to conform to the original form of the buccal side of a tooth; and a lingual coverage part produced to conform to the original form of the lingual side of the tooth, wherein the buccal coverage part and the lingual coverage part are engaged or in close contact with each other to cover a ground tooth.

2. A dental prosthesis comprising a lingual coverage part, the lingual coverage part completely covering to the lingual side, the occlusal surface and the greatest bulge portion of the buccal side, or covering to the infrabulge or the buccal side margin by forming a groove at the greatest bulge portion of the buccal side.

3. A dental prosthesis comprising a buccal coverage part, the buccal coverage part completely covering to the buccal side, the occlusal surface and the greatest bulge portion of the lingual side, or covering to the infrabulge or the lingual side margin by forming a groove at the greatest bulge portion of the lingual side.

4. A dental prosthesis according to claim 1, wherein the engaged portion between the buccal coverage part and the lingual coverage part has an acute angle so as to prevent melting of cement by obtaining a close contact level using ductility of metal during mastication.

5. A dental prosthesis according to claim 4, wherein the engaged portion or the close contact portion between the buccal coverage part and the lingual coverage part may have one of a bevel-faced form, a V-shaped from and a U-shaped form.

6. A method for manufacturing a dental prosthesis comprising the steps of duplicating a work pattern, waxing up the duplicated pattern, holding a sprue on the duplicated pattern in a state where the duplicated pattern is waxed up, investing, burning out, and casting the wax pattern.

7. A dental prosthesis comprising a fixed dental prosthesis (V) integrally attached on the buccal side or the lingual side of a number of teeth in series in order to fix the teeth using rigidity of metal.

8. A dental prosthesis according to claim 7, wherein the fixed dental prosthesis covers the buccal and lingual sides, the occlusal surface of the tooth, which is not in contact with the opposite tooth, and the nonfunctional cusp.

9. A dental prosthesis according to claim 7, wherein a dent is formed on the buccal or lingual side (including or not including the occlusal surface), and a projection is formed on the fixed dental prosthesis (Y) in the same form as the indented portion in order to increase holding force of the fixed dental prosthesis.

10. A dental prosthesis according to claim 9, wherein the indented portion may adopt one of a rectangle form, a U-shaped form, a V-shaped form, a dot form, a hole form, and a scratch form.

11. A dental prosthesis according to one of claim 7, wherein if there is an undercut, the dental prosthesis is produced by the steps of duplicating a work pattern, waxing up the duplicated pattern, holding a sprue on the duplicated pattern in a state where the pattern is waxed up, investing, burning out and casting the wax pattern, and bonding it to the work pattern using elasticity of metal, but if there is no undercut, the dental prosthesis is produced by the steps of waxing up a work pattern, holding a sprue on the wax pattern, investing, burning out, and casting the wax pattern.
